(19) United States
(12) Patent Application Publication
(10) Pub. No.: US 2006/0205455 A1
(43) Pub. Date: Sep. 14, 2006

(54) INTERACTIVE CONTROLLER WITH AN INTEGRATED DISPLAY AND INTERFACE TO A SECOND CONTROLLER WITH STAND-ALONE DISPLAY

(75) Inventors: Steven Rehkemper, Chicago, IL (US); Nicholas Grisolia, Chicago, IL (US); Kerry Phillips, South Holland, IL (US); Lo Tak Kwong, Fo Tan (HK)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: REHCO, LLC, Chicago, IL (US)

(21) Appl. No.: 10/906,811

(22) Filed: Mar. 8, 2005

(51) Int. Cl. A63F 13/00

(52) U.S. Cl. 463/1

(57) ABSTRACT

The present invention provides for an interactive controller with an integrated display and with an interface to a second controller, that is in further communication with a stand-alone display. The interactive controller further includes a plurality of operation buttons positioned for manipulation by a user, a first electronic application stored in the interactive controller, a processor for generating control signals to control the first electronic application based upon input received from the operation buttons and for generating images on the display device in response thereto. The interactive controller includes a transmitter for transmitting wireless signals to the second controller. The second controller includes a receiver and is operatively connected to a stand-alone display. The second controller also includes a second electronic application and a processor for generating control signals to control the second electronic application based upon input received from the operation buttons and for generating images on the stand-alone display in response thereto.

### FIELD OF THE INVENTION

The present invention relates to an interactive controller with an integrated display and an interface to a second controller with a stand-alone display.

### BACKGROUND OF THE INVENTION

Interactive controller units are well known in the industry; such controller units take such forms as computer video game controllers and other electronic consumer devices (such as wireless email devices, PDA's, etc.,). While these interactive controller units are known, the level of interactivity or connectivity to other devices are limited. U.S. Pat. No. 6,773,349 provides for one such controller. The '349 patent includes a video game controller with an integrated video display. The user attaches the controller by a cord to a game system box which sends signals to the controller unit for display on the integrated video display as well as display on a stand-alone display. The separate game system controls the programming and sends all control signals to the controller unit. Thus, the controller unit cannot function separate and apart from the game system. Other controller units or electronic consumer devices also have integrated video displays, but include programming such that the controller unit can function alone. Such controller units may then be placed in a cradle, which connects the controller unit to a computer such that information is synchronized with information on the user's computer. Any information entered into the controller unit is then available on the user's computer. However, the electronic consumer devices must be kept cradled to send information to the user's computer. The present invention addresses and solves these problems found in the prior art.

### SUMMARY OF THE INVENTION

In accordance with the present invention an interactive controller is provided with an integrated display and with an interface to a second controller, that is in further communication with a stand-alone display. The interactive controller further includes a plurality of operation buttons positioned for manipulation by a user, a first electronic application stored in the interactive controller, a processor for generating control signals to control the first electronic application based upon input received from the operation buttons and for generating images on the display device in response thereto. The interactive controller includes a transmitter for transmitting wireless signals to the second controller. The second controller includes a receiver and is operatively connected to a stand-alone display. The second controller also includes a second electronic application and a processor for generating control signals to control the second electronic application based upon input received from the operation buttons and for generating images on the stand-alone display in response thereto.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is an interactive controller in accordance with the present invention;

FIG. 2 is the interactive controller in use with a second controller and stand-alone display;

FIG. 3 is a block diagram of the interactive controller and second controller and stand-alone display;

FIG. 4 illustrates the interactive controller in use with a second controller and stand-alone display with overlay features; and

FIG. 5 is an interactive controller with integrated touch display in use with a second controller and stand-alone display.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

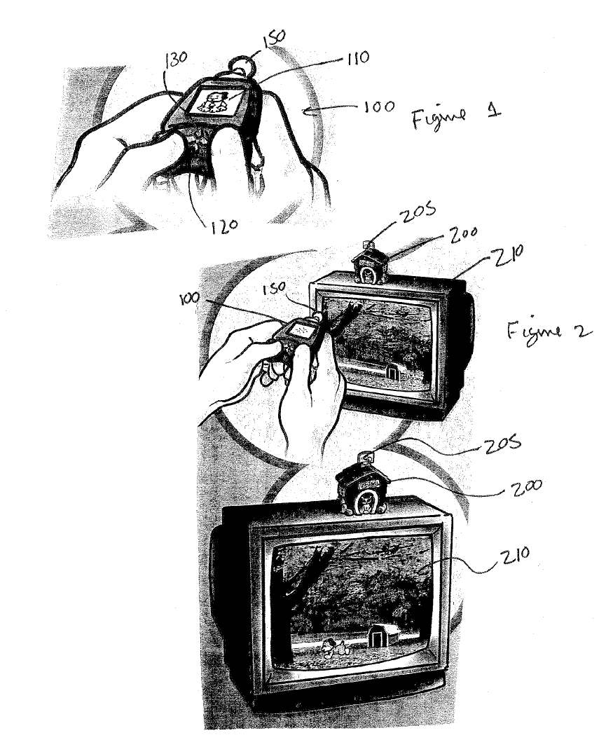

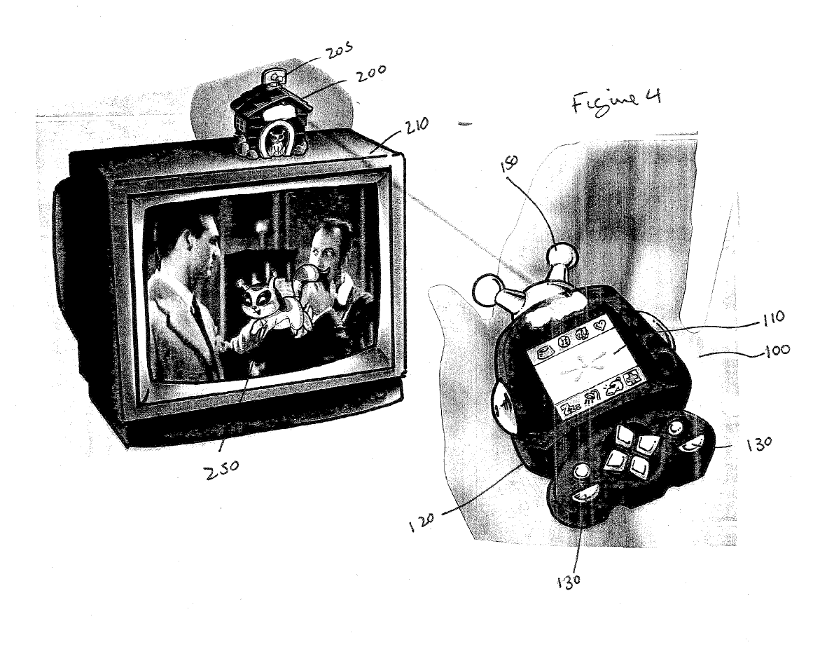

Referring now to FIG. 1 and FIG. 3, an interactive controller 100 includes an integrated display 110. The interactive controller 100 is a hand held unit having a body portion 120. A plurality of operation buttons 130 are positioned for manipulation by a user on the body portion 120. The interactive controller 100 includes a processor 135 and a memory device 140 for storage and operation of a software driver or engine. The software driver runs an application 145 stored in the interactive controller 100 which generates and displays images on the integrated display 110. The processor also generates control signals to control the application based upon the inputs received from the buttons 130, further controlling the images on the integrated display 110. In various embodiments the interactive controller 100 could control a virtual pet, a video game, wireless email device, PDA, wireless communication device, etc. Since these devices are well known, it is not outside of the scope of the invention to provide any of such interactive controller devices 100. The present invention however, provides for additional features not found in the prior art.

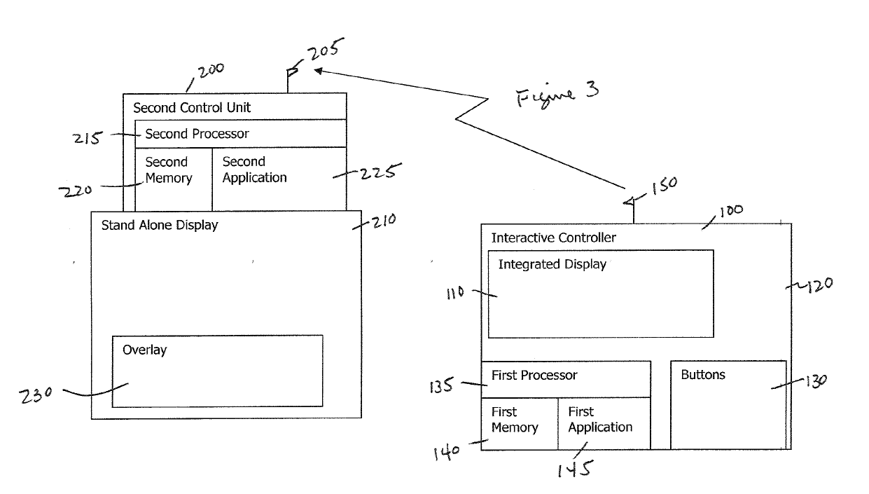

Referring now also to FIG. 2, the interactive controller device 100 includes a transmitter 150, such that various signals can be wirelessly transmitted to a remote second control unit 200. This interface to a second controller permits the interactive controller device 100 to communicate to and control another controller. The second control unit 200 is in further communication with a stand-alone display 210, such as a television or monitor. The second control unit 200 includes a receiver 205 for the receipt of any transmission signals from the interactive controller device 100. The second control unit 200 also includes a processor 215 and a memory device 220 for storage and operation of a software driver or engine. The software driver runs an application 225 stored in the second control unit 200 and produces images on the stand-alone display 210. The processor 215 also generates control signals to control the application and images in the second control unit 200 based upon the inputs received from the buttons 130 on the interactive controller 100. As such, when the second control unit 200 is activated, a user manipulating the buttons 130 on the interactive controller 100 will now generate control signals to control the application running in the second control unit 200 which will create displays on the stand-alone display 210.

Those of skill will understand that the second control unit 200 will operatively connect with an input and/or output (I/O) port on the stand-alone display. Drivers in the second control unit 200 cause the second processor 215 to communicate with the stand-alone display through the operatively connected I/O port. Drivers will be understood to enable the second processor to convey information to/from the second control unit 200 to the stand-alone display 210 for viewing thereon of such information supplied by second control unit 200. The second control unit 200 may be operatively connectable to I/O port for communicating such information to the stand-alone display in accordance with a defined protocol. Furthermore, the second control unit 200 may also be connected to a videocassette player (VCR) or DVD player's I/O port. Those of skill will appreciate that I/O port may be implemented in any number of ways. For example, it may be implemented as a card slot/connector positioned on the exterior housing of an electronics product that includes a stand-alone display. In addition, the I/O port may be an uniform serial bus (such as one found on a computer) or other serial or parallel port.

The software applications would be written specially for the invented system and would be dedicated or open ended. Applications could be designed to play games, receive messages, news, sports, or other communications.

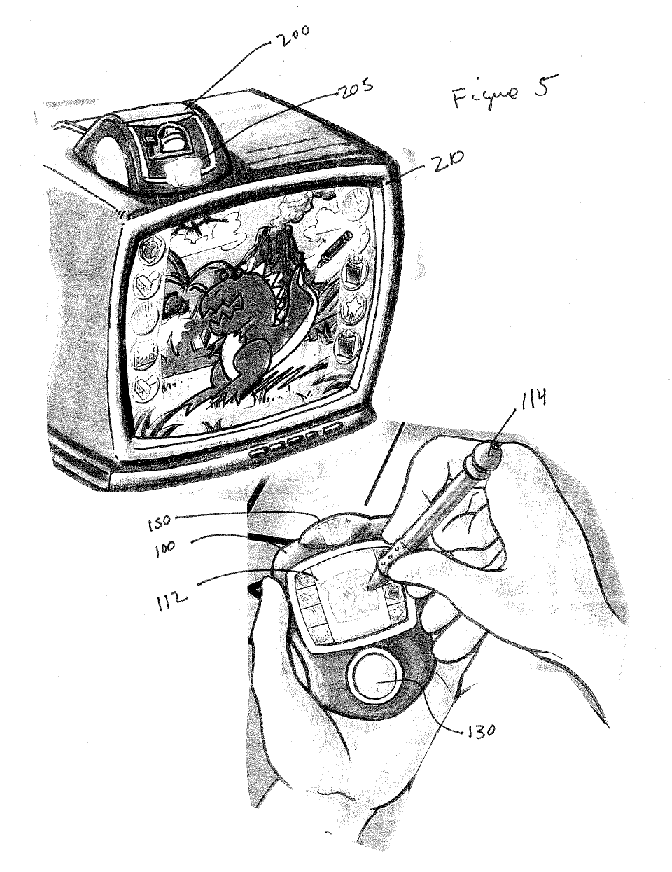

Referring now also to FIG. 4, in another embodiment, the second control unit 200 includes necessary hardware and software to overlay the graphics images on the normal images already being displayed on the stand-alone display. In FIG. 3, the overlay 230 may be a limited area on the display 210, or the overlay 230 may be the entire display. This permits the user of the interactive controller 150 to play a game, control a virtual toy, view messages or news, while a normal program is being run or viewed on the stand-alone display. Such overlay systems which allow the synchronization of two or more video or graphic sources are known. As mentioned the overlay can be over any normally displaying image, dependant upon how the second control unit 200 is operatively connected to the stand alone display. For example, if a DVD or other video player is attached through the second control unit, the overlay may be done over a playing DVD or video. Similarly, if the second control unit is operatively connected to a cable, digital or other media transmission the overlay is done over the normally played media transmission.

Referring now to FIG. 5, the interactive controller 100 may include an integrated touch display 112. An interactive pen 114 would replace or work along with buttons 130.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. An interactive controller with an integrated display with an interface to a second controller in communication with a stand-alone display,
the interactive controller comprising:
a hand held body having a plurality of operation buttons positioned for manipulation by a user,
an integrated display secured to said hand held body,
a first electronic application stored in said interactive controller,
a processor for generating control signals to control said first electronic application based upon input received from the operation buttons and for generating images on the integrated display in response thereto, and
a transmitter in communication with the processor for sending wireless signals to the second controller in response to the input received from the operation members, and
the second controller comprising:
means for communicating with said stand-alone display,
a second electronic application,
means for wirelessly receiving said signals from said interactive controller, and
a second processor for generating control signals to control said second electronic application based upon input received from the operation buttons and for generating images on said stand-alone display.

2. The interactive controller of claim 1, wherein the images generated on said stand-alone display by the second processor in the second controller are further overlaid upon other images displayed on said stand-alone display.

3. The interactive controller of claim 1, wherein the stand-alone display is a television.

4. An interactive controller with an integrated display with an interface to a second controller in communication with a stand-alone display,
the interactive controller comprising:
a hand held body having a plurality of operation buttons positioned for manipulation by a user,
an integrated display secured to said hand held body,
a first electronic application stored in said interactive controller,
a processor for generating control signals to control said first electronic application based upon input received from the operation buttons and for generating images on the integrated display in response thereto, and
a transmitter in communication with the processor for sending wireless signals to the second controller in response to the input received from the operation members, and
the second controller comprising:
means for communicating with said stand-alone display,
a second electronic application,
means for wirelessly receiving said signals from said interactive controller, and
a second processor for generating control signals to control said second electronic application based upon input received from the operation buttons and for generating images on said stand-alone display, wherein the images generated on said stand-alone display by the second processor in the second controller are further overlaid upon other images displayed on said stand-alone display.
